(19) United States
(12) Patent Application Publication
(10) Pub. No.: US 2015/0096031 A1
(43) Pub. Date: Apr. 2, 2015

(54) SYSTEM AND METHOD FOR PROVIDING SIMPLIFIED END-TO-END SECURITY FOR COMPUTING DEVICES IN STANDALONE, LAN, WAN OR INTERNET ARCHITECTURES

(71) Applicants: Justin H. N. Benoit, West Richland, WA (US); Clark R. Moore, San Ramon, CA (US)

(72) Inventors: Justin H. N. Benoit, West Richland, WA (US); Clark R. Moore, San Ramon, CA (US)

(21) Appl. No.: 14/484,753

(22) Filed: Sep. 12, 2014

Related U.S. Application Data
(60) Provisional application No. 61/883,230, filed on Sep. 27, 2013.

(51) Int. Cl. G06F 21/56

(52) U.S. Cl. CPC G06F 21/56
USPC 726/24

(57) ABSTRACT

The present invention generally relates to systems and methods for end-to-end security for computing devices in standalone, LAN, WAN or Internet architectures. Specifically, the present invention relates to a computer implemented system and method for providing simplified end-to-end security for computing devices in standalone, LAN, WAN or Internet architectures.

### FIELD OF THE INVENTION

The present invention generally relates to systems and methods for end-to-end security for computing devices in standalone, LAN, WAN or Internet architectures. Specifically, the present invention relates to a computer implemented system and method for providing simplified end-to-end security for computing devices in standalone LAN, WAN or Internet architectures.

### CROSS REFERENCE TO RELATED APPLICATIONS

This application claims the benefit of U.S. Provisional Patent Application No. 61/883,230 filed Sep. 27, 2013 and entitled “System And Method for Providing Simplified End-To-End Security for Computing Devices in Standalone, LAN, WAN or Internet Architectures” the entire disclosure of which is incorporated herein by reference.

### BACKGROUND OF THE INVENTION

Computer security is complex and often too difficult for non-technical people to understand and use properly. This leaves millions of end-users vulnerable to malware and other malicious behavior on the Internet and other wide area networks (WAN), local area networks (LAN) or any combination thereof. Today, in order to protect information and privacy of a user, the user needs a suite of security products from multiple vendors to cover all the various avenues of attack possible by those who want access to the protected information.

Users need to know what security products to look for, and how to configure the security products, keep them up-to-date, and use the security products properly. This requires not only knowledge and understanding of the problems and critical security issues, but also time and effort to maintain and analyze any current, new or emerging issues and update the security products accordingly.

Therefore, there is a need in the art for a system and method for providing simplified end-to-end security for computing devices. These and other features and advantages of the present invention will be explained and will become obvious to one skilled in the art through the summary of the invention that follows.

### SUMMARY OF THE INVENTION

Accordingly, it is an object of the present invention to provide a system and method that protects against malware and provides privacy with minimal oversight or input from a user.

According to an embodiment of the present invention, a system for providing simplified end-to-end security for computing devices in standalone, LAN, WAN or Internet architectures; the system comprising: a multi-aspect security module, comprising computer-executable code stored in non-volatile memory, a processor, and a communications means, wherein the multi-aspect security module, the processor, and the communications means are operably connected and are configured to: create a sandbox on a host system upon receiving launch instructions from a user, wherein file associations are generated with the host system; configure necessary permissions to the host system, wherein the sandbox establishes read permissions from the host and write permissions to the host system; establish an encrypted connection between the host system and a remote computing system; launch one or more virtual applications from the sandbox on the host system; request authentication from the user to provide access to the remote system via the encrypted connection, which request may also be automated, requiring no user input; facilitate an outbound data transmission to an external network, wherein the outbound data transmission is sent from a requesting virtual application via the encrypted connection; receive an inbound data transmission from the external network, wherein the inbound data transmission is a response to the outbound data transmission; scan the inbound data transmission for malicious content using the remote computing system; determine whether the inbound data transmission is corrupted with the malicious content; upon determining the inbound data transmission is free of the malicious content: permit the inbound data transmission to return to the requesting virtual application on the host system; and upon determining the inbound data transmission is corrupted with malicious content: block the inbound data transmission from returning to the virtual application on the host system.

According to an embodiment of the present invention, the multi-aspect security module, the processor, and the communications means are operably connected and are further configured to: deny execution of executable code associated with a first virtual application within the sandbox, wherein said first application is not approved during a compilation cycle; allow execution of executable code associated with a second virtual application within the sandbox, wherein said second application is approved during the compilation cycle.

According to an embodiment of the present invention, the multi-aspect security module, the processor, and the communications means are operably connected and are further configured to: create a new sandbox on the host system.

According to an embodiment of the present invention, the encrypted connection is a secure shell providing an encryption tunnel between the host system and the remote computing system that supports multiple protocols selected from a group of protocols comprising web, mail, video conferencing, and instant messaging, and all other communication and application protocols.

According to an embodiment of the present invention, the encrypted connection is comprised of one or more encrypted connection types selected from a group of encrypted connection types comprising secure socket layer, secure shell, and virtual private network.

According to an embodiment of the present invention, the inbound data transmission is scanned with signature-based anti-malware engines.

According to an embodiment of the present invention, the inbound data transmission is scanned with heuristic-based anti-malware engines.

According to an embodiment of the present invention, a method for providing simplified end-to-end security for computing devices in standalone, LAN, WAN or Internet architectures; the method comprising the steps of: creating a sandbox on a host system upon receiving launch instructions from a user, wherein file associations are generated with the host system; configuring necessary permissions to the host system, wherein the sandbox establishes read permissions from the host and write permissions to the host system; establishing an encrypted connection between the host system and a remote computing system; launching one or more virtual applications from the sandbox on the host system; requesting authentication from the user to provide access to the remote system via the encrypted connection; facilitating an outbound data transmission to an external network, wherein the outbound data transmission is sent from a requesting virtual application via the encrypted connection; receiving an inbound data transmission from the external network, wherein the inbound data transmission is a response to the outbound data transmission; scanning the inbound data transmission for malicious content using the remote computing system; determining whether the inbound data transmission is corrupted with the malicious content; upon determining the inbound data transmission is free of the malicious content: permitting the inbound data transmission to return to the requesting virtual application on the host system; and upon determining the inbound data transmission is corrupted with malicious content: blocking the inbound data transmission from returning to the virtual application on the host system.

According to an embodiment of the present invention, the method further comprises the steps of: denying execution of executable code associated with a first virtual application within the sandbox, wherein said first application is not approved during a compilation cycle; and allowing execution of executable code associated with a second virtual application within the sandbox, wherein said second application is approved during the compilation cycle.

According to an embodiment of the present invention, the method further comprises the steps of: creating a new sandbox on the host system.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3A is an illustration of an exemplary process flow, in accordance with an embodiment of the present invention—depicting the process related to single executable launch;

FIG. 3B is an illustration of an exemplary process flow, in accordance with an embodiment of the present invention—depicting the process related to user authentication and data flow; and

FIG. 3C is an illustration of an exemplary process flow, in accordance with an embodiment of the present invention—depicting the process related to removal of malware from a secured computing device.

### DETAILED SPECIFICATION

The present invention generally relates to systems and methods for end-to-end security for computing devices in standalone LAN, WAN or Internet architectures. Specifically, the present invention relates to a computer implemented system and method for providing simplified end-to-end security for computing devices in LAN, WAN or Internet architectures.

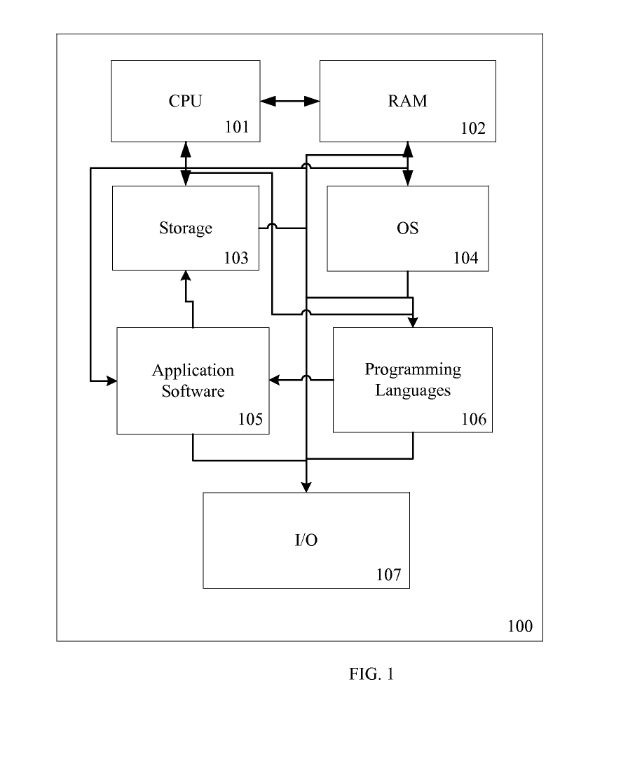

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central Processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106, and one or more input/output devices/means 107. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

According to an embodiment of the present invention, the system provides a series of methods to combine multi-layered malware protection, multi-protocol encrypted tunnel handling, and proxy capabilities for privacy, user flexibility and ease of use in a single system. In other embodiments, the system may be comprised of a subset of the aforementioned methods. A preferred embodiment of the present invention provides a system with capabilities of ensuring performance of all aforementioned methods. A discussion of each of these individual methods ensues in this application.

According to an embodiment of the present invention, the systems and methods described herein may be implemented through the use of a multi-aspect security module. In a preferred embodiment the multi-aspect security module is configured to guard a computing device against malware and provide privacy and security to the user of a computing device. In the preferred embodiment, measures that might be used include, but are not limited to, sandbox technology, malware scanning, various encryption protocols, and system recovery tools. One of ordinary skill in the art would appreciate that there are many methods and measures that could be implemented to provide security and privacy through a multi-aspect security module, and embodiments of the present invention are contemplated for use with and such methods and measures.

In a preferred embodiment of the present invention, the system protects against malware and provides privacy, user flexibility and ease of use through the combination of the benefits of sandbox technology, signature- and heuristic-based malware scanning, single-click system recovery, anonymous transparent proxies, multi-protocol encryption tunnel, broad application support, split-tunneling and portability in a single system. Alternative embodiments of the system may be configured to provide any subset of the aforementioned protections.

According to an embodiment of the present invention, the system is configured to provide layered malware protection (LMP). Layered malware protection is provided by the system in part by scanning all traffic (e.g., network traffic) with signature- and heuristic-based anti-malware engines before the traffic reaches a host computing device. Any malware identified in such scan is handled accordingly. This eliminates pop-ups and administration requests from the host computing device, thereby removing the annoyance and frustration of having to manually process these concerns as an end-user.

According to an embodiment of the present invention, a sandbox is utilized and configured to reduce the ability for computer code to access the host computing device to the maximum amount possible, while still permitting full functionality and an uninhibited end-user experience. Any malware or other malicious computer code in the sandbox that can be seen (i.e., browser toolbar add-ons, pop-up advertisements, etc.) can be easily removed with a single interaction with the host computing system. Interactions that may be utilized to engage the removal of such malware or other malicious computer code may include, but are not limited to, interaction with a desktop icon, interaction with a browser icon, a mouse click, a keyboard command, interaction with a touch screen element or other human interface device (HID), or any combination thereof. One of ordinary skill in the art would appreciate that there are numerous types of interactions that could be utilized to engage the removal of malware or other malicious computer code from the sandbox, via the system.

According to an embodiment of the present invention, the system generally does not perform signature scanning, heuristic scanning or behavioral monitoring within the sandbox. Certain embodiments of the present invention may be configured to do so, but any malware that was not detectable at the Remote Computing Resources (RCR) component of the system, such as by a multi-engine antimalware signature- and heuristic-based scanner element of the RCR, prior to entering sandbox would very likely be unnoticed as the same or similar scans would occur (e.g., same signature database elements). Instead, the sandbox is designed to “deny all” software code from accessing host resources outside of the sandbox. Since nothing occurs outside of the resources belonging to the sandbox (e.g., virtual host resources), an occasional restoration of the sandbox by the system restores the sandbox to its original state, unaffected by any malicious software code. Since end-user custom settings (i.e. customer profile) do not carry executable code, the custom settings can be synchronized with the RCR and restored automatically at any time.

According to an embodiment of the present invention, the system may be further configured to provide multi-protocol encrypted tunnel & proxy (MPETP) services in an automated manner and with zero end-user interaction. In a preferred embodiment of the present invention these MPETP services include one or more encryption means between the end-user computing device and the RCR of the system.

One of ordinary skill in the art would appreciate that there are two common methods used to provide an encrypted connection over the Internet. The first is Hypertext Transfer Protocol Secure (HTTPS). HTTPS leverages SSL/TLS (Secure Sockets Layer/Transport Layer Security) used by financial institutions, e-commerce, etc., and is identified by the prefix (https://). This type of encryption tunnel cannot handle other types of protocols, for example, email, video conferencing and instant messaging, therefore is restricted to common web-based traffic. The second common method is the use of a Virtual Private Network (VPN) connection, including, but not limited to browser and non-browser based VPN connections. These connections are very common for allowing remote workers to access company resources while on travel or telecommuting. A VPN tunnel supports all protocols unlike SSL/HTTPS; however, for use as a commercial service versus remote access to company resources, there are significant drawbacks. A VPN tunnel binds to the network adapter card and connects the entire end-user computing device to the other end from a logical perspective. The end-user computing device becomes part of the overall network and all traffic leaving the end-user computing device is sent to the other end rather than just the web browsing traffic.

In some cases, a VPN can be configured for sending specific traffic; however, this is not the default and is not easy for an end-user without specialized knowledge to manually configure. By its very nature, the VPN tunnel also creates the ability for the service provider to access the end-user system, creating significant security vulnerability. In a managed VPN system, the end-user is highly reliant on the integrity of the company managing the VPN system, all of its employees and consultants, and their technical competence to ensure the end-user's VPN connection is not open to the entire Internet.

In a preferred embodiment of the present invention, a different approach is utilized. In this preferred embodiment, the system does not use SSL/HTTPS or VPNs. Instead, the system leverages a well-established encryption solution known as Secure Shell (SSH). Secure Shell supports a feature known as “tunneling”. With the correct configuration, a tunneled SSH connection can support multiple protocols, including, but not limited to, web, mail, video conferencing and instant messaging. Similar to SSL/HTTPS, an SSH connection does not bind to the network interface card like a Virtual Private Network connection. Therefore, only user-selected applications will send traffic through the tunnel. The selection of applications to use the SSH tunnel is simple and puts the end-user in complete control. Also, similar to SSL/HTTPS, there is no open return connection to the end-user's computing device like there is with a VPN connection. Advantageously, this preferred embodiment of the present invention combines the best of SSL/HTTPS and VPN by creating a flexible, safe and user-friendly secure connection.

In certain embodiments of the present invention, sandboxed applications can be configured to automatically use the SSH tunnel or other encrypted tunnel/connection. These embodiments eliminate any user intervention and supports a zero-configuration/zero-management setup. In these embodiments, generally, a user has the ability to stop using an encrypted tunnel, allowing the user to retain control if desired, but generally allows for the user to be hands off unless otherwise desired.

According to an embodiment of the present invention, the system is configured to provide protection beyond just web browsing or protecting the local system from other attack vectors in various software applications. Rather, the system further provides data encryption means that is always-on, providing privacy and data protection for the end-user regardless of the connection they are using. The encrypted tunnel is automatically connected to components of the system located on the end-user computing device, yet allows the end-user to select any application that supports proxies to leverage the encrypted connection at their discretion, thereby providing user flexibility in choice of applications. In addition to malware protection and data encryption, embodiments of the present invention may be configured to include a built-in anonymous feature that is automatically enabled and easily turned off and on by the end-user. In other embodiments, the anonymous feature may be initially disabled and still easily turned off and on by the end-user.

According to an embodiment of the present invention, the system may also be fully portable and can be used on any compatible computing device without installation and without leaving any personal information or other data behind, further providing the user with flexibility.

According to an embodiment of the present invention, one or more components of the system may be packaged as a single executable application, and can be installed on a computing device by a few keystrokes, mouse clicks or other interaction (e.g., interaction with a capacitive touch screen). In general, embodiments of the present invention allow for all the features of the system to be available with a single interaction. The system thereby is able to provide seamless integration, ease of use and zero configuration while securing one or more computing devices of an end-user.

### EXEMPLARY EMBODIMENTS

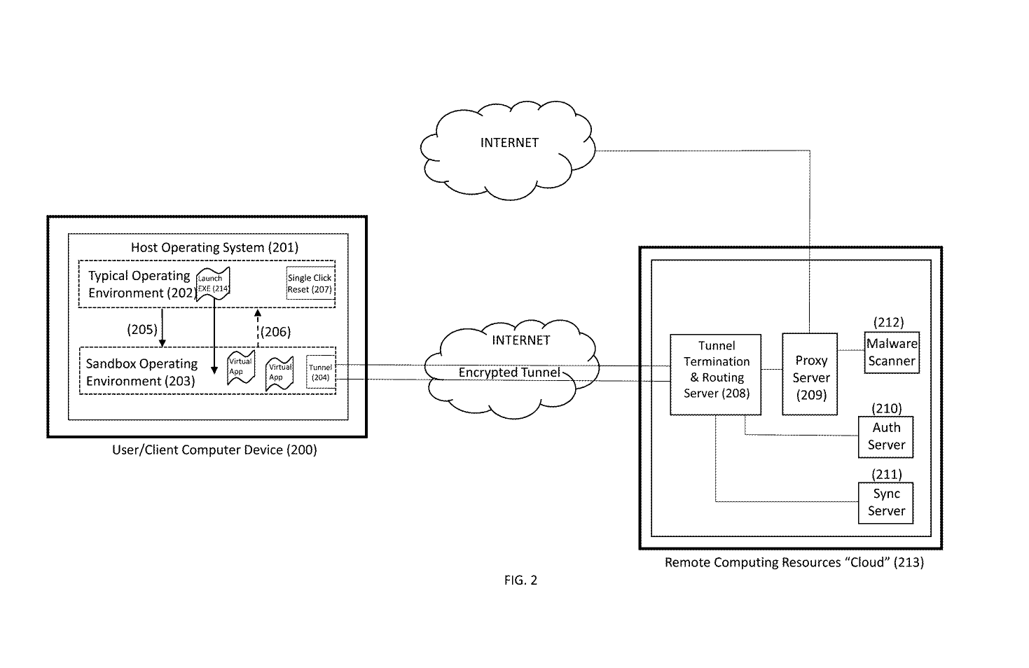

Turning now to FIG. 2, a network schematic of a system, in accordance with an embodiment of the present invention, is shown. In this embodiment, the system is broken into two distinct and potentially independent components. First is the User/Client Computer Device (i.e., computing device) 200, comprising a computing device as described herein and generally comprising one or more of a host operating system (OS) 201, a typical operating environment (OE) 202, a sandbox operating environment (OE) 203, one or more connections between the typical OE 202 and the sandbox OE 203 (connections labeled 205, 206) and a interaction element (i.e., single click reset 207). The second component is the RCR (i.e., cloud component) 213, comprising one or more of a tunnel termination & routing server 208, a proxy server 209, an authentication server 210, a synchronization server 211 and a malware scanner 212. While the description of each of components 208-211 reference a server, it would be understood by one of ordinary skill in the art that each of these servers could be contained on a single server or any number of local or distributed computing systems in order to provide all the services identified by and in conjunction with the RCR.

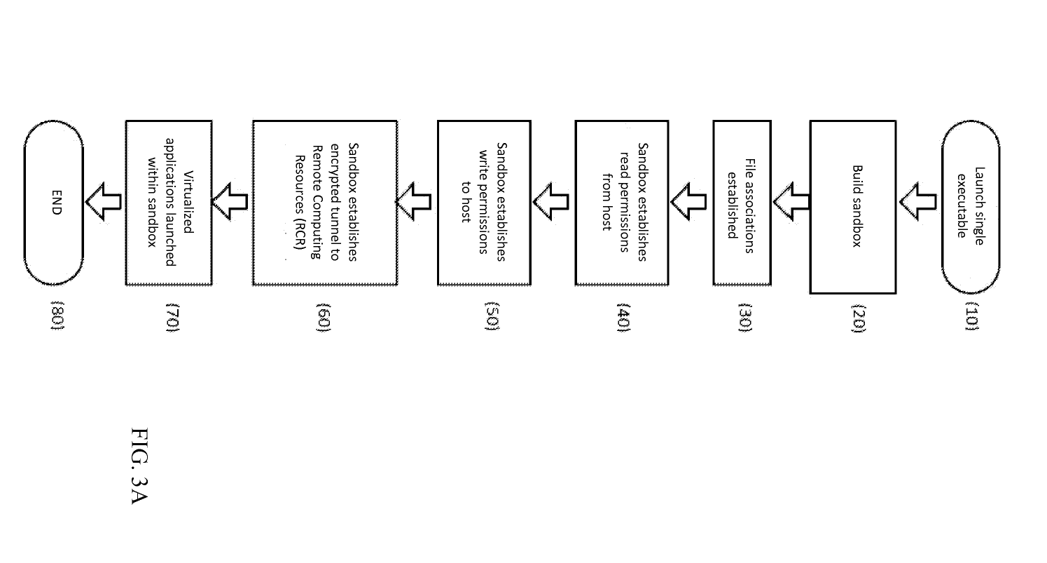

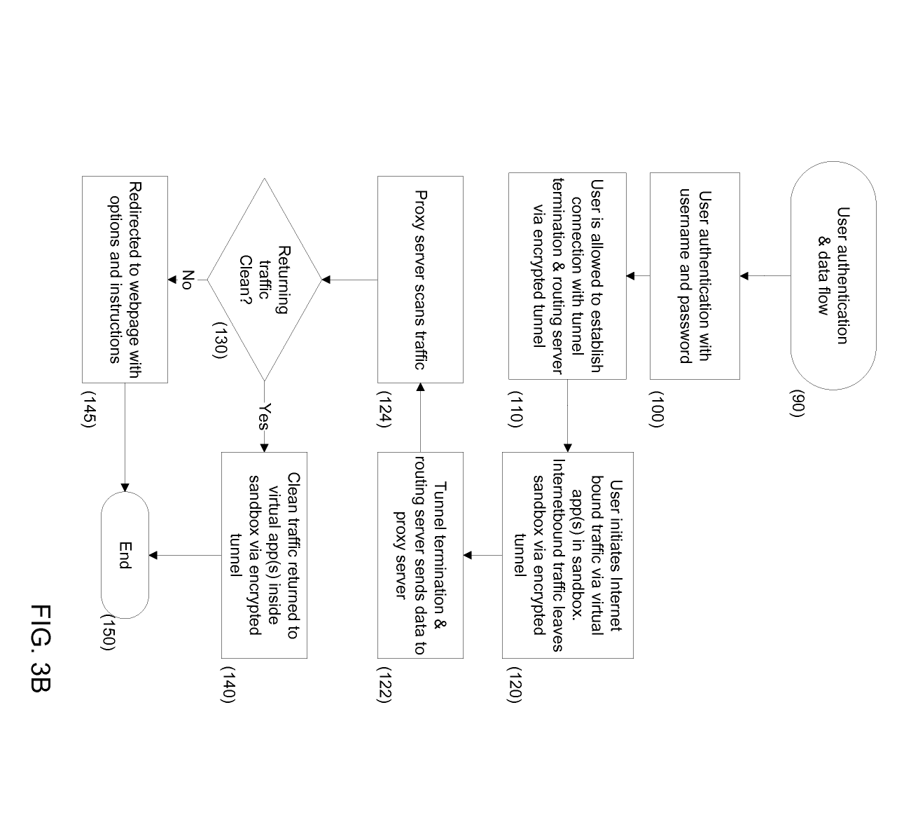

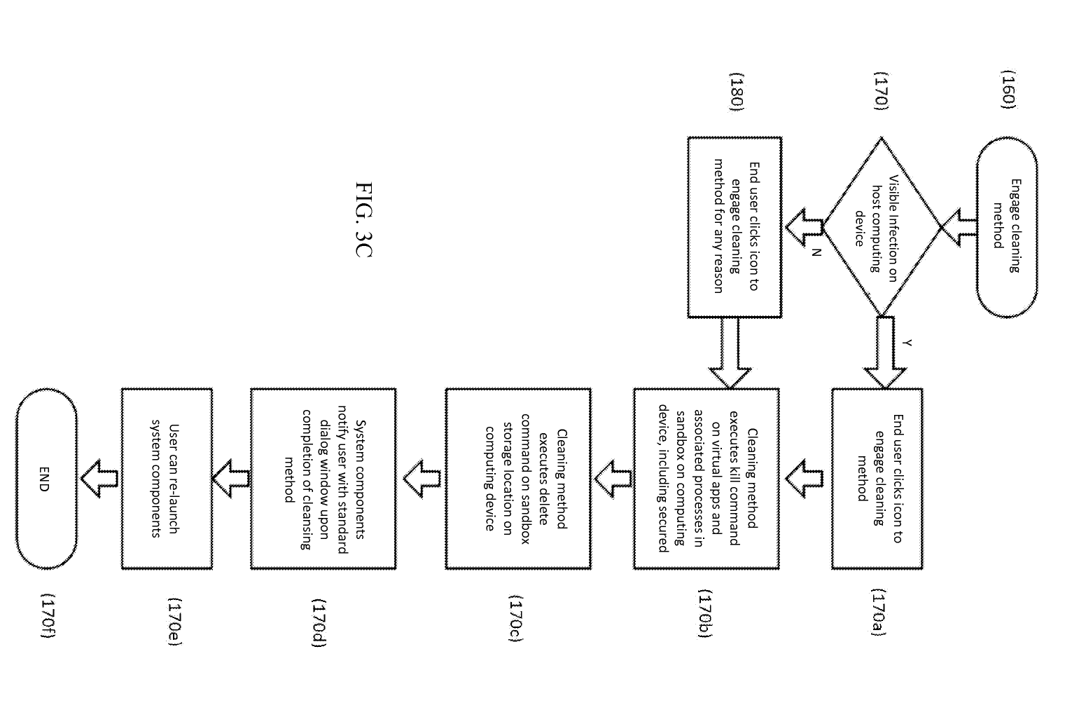

Turning now to FIG. 3A, an illustration of an exemplary process flow, in accordance with an embodiment of the present invention, depicting the process related to single executable launch, is shown. The user first engages the system components (10) to start the configuration and launch process.

After the user launches the downloaded components, the executable will automatically build the sandbox (20) without requiring any user input or intervention. The system automatically creates the necessary file associations (30) and configures pre-defined read (40) and write (50) permissions to the host system.

The system will launch a secured tunnel. The secure tunnel will create an encrypted connection from the system components on the host computing device to the components of the system located on the RCR.

After the secured tunnel is launched and established, the system will launch one or more virtualized applications bundled inside of the sandbox system (70). At this point, this portion of the method (setup/configuration) ends.

Turning now to FIG. 3B, an illustration of an exemplary process flow, in accordance with an embodiment of the present invention, depicting the process related to user authentication and data flow, is shown. After successful launch of the one or more virtual applications within system components on the host computing device, the user will be prompted to authenticate (100) in order to access the RCR components of the system. In some instances, the user may authenticate when they first launch the executable (10), FIG. 3A, and in other instances, the authentication may be automated, requiring no user input.

Upon successful authentication, the user is allowed to establish a connection, via the secured tunnel, with the proxy server (110) in the RCR component of the system. The user is then able to initiate an Internet bound data request (120), and the data request is sent across the secured (i.e., encrypted) tunnel (120).

Traffic returning from the Internet is scanned by a multi-engine signature- and heuristic-based antimalware system (130). This process occurs at the RCR components of the system, as to prevent any malicious code or content from reaching the host computing device of the user. If the traffic returning from the Internet is free of malicious code or content (“clean”), then the “clean” traffic is returned to the requesting virtual application running on the system components of the user's host computing device (140). If the traffic returning from the Internet is not free of malicious code or content, then the traffic is not returned to the virtual application running on the system components of the user's host computer and the user is redirected to a webpage with further options and instructions (140).

The user may operate within steps 100-140 throughout the running duration of the system components on host computing devices. For example, web surfing various sites, email, instant messaging, video conferencing, etc. Only upon closure of an instance of the system components on the host computing system will steps 10 through 120 start over again.

Turning now to FIG. 3C, an illustration of an exemplary process flow, in accordance with an embodiment of the present invention, depicting the process related to removal of malware from a secured computing device, is shown. In the event malware infects the sandbox of the system components located on the host computing device, the user can invoke the cleansing method (160) and return to step 10 (i.e., rebuilding of a new sandbox) at any time.

When the user engages the cleansing method (generally though interaction with the system components, such as via a desktop icon, which may include a “one-click” interaction) (170a), the system components located on the host computing device execute a kill command (170b) on one or more virtual applications and associated processes in the system components, generally including the secured tunnel when applicable.

According to an embodiment of the present invention, the user may engage the cleansing method through a one-click interaction with a system component. In a preferred embodiment, the one-click interaction may be a user employing a single-mouse click, for example a single-mouse click of a desktop icon. In an alternate preferred embodiment, the one-click interaction may be a single keystroke. As an illustrative example, the user may engage the cleansing method by employing a single mouse-click or keystroke. This one-click interaction initiates the cleansing method and provides users of all skill levels the ability to remove malware contained in a sandbox environment and resets applications contained within the sandbox environment to their respective default settings without further user intervention. One of ordinary skill in the art would appreciate that there are numerous manners by which the cleansing method could be engaged, and embodiments of the present invention are contemplated for use with any such manner of engagement.

According to an embodiment of the present invention, the cleansing method is an expandable method. In a preferred embodiment, the cleansing method is expandable in that it can be configured to include any application in the sandbox environment. It is not restricted, for example, to web browsers only. This is significant given that malware can enter a host computing device through numerous vectors. These vectors include, but are not limited to, email applications, video player applications, PDF applications, Microsoft Office documents, etc. In the preferred embodiment, the cleansing method is capable of cleaning malware from any application that resides in the sandbox environment. One of ordinary skill in the art would appreciate there the cleansing method could be used and expanded for a variety of functions, and embodiments of the present invention are contemplated for use with any such function.

The system components on the host computing device further execute a delete command of programs (170c) on the storage media location of the sandbox component of the system components located on the host computing device in order to ensure malicious code cannot escape the sandboxed area.

The system components then notify the end-user with a standard dialog window or prompt (170d) upon completion of the cleansing method.

The user can re-launch the system components (170e). Alternatively, the system can be configured to automatically re-launch upon completion of a cleansing method. Upon re-launch, steps 10-120 begin again.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing simplified end-to-end security for computing devices in standalone, LAN, WAN or Internet architectures; said system comprising:
a multi-aspect security module, comprising computer-executable code stored in non-volatile memory,
a processor, and
a communications means,
wherein said multi-aspect security module, said processor, and said communications means are operably connected and are configured to:
create a sandbox on a host system upon receiving launch instructions from a user, wherein file associations are generated with said host system;
configure necessary permissions to said host system, wherein said sandbox establishes read permissions from said host and write permissions to said host system;
establish an encrypted connection between said host system and a remote computing system;
launch one or more virtual applications from said sandbox on said host system;
request authentication from said user, or provide automated authentication, to provide access to said remote system via said encrypted connection;
facilitate an outbound data transmission to an external network, wherein said outbound data transmission is sent from a requesting virtual application via said encrypted connection;
receive an inbound data transmission from said external network, wherein said inbound data transmission is a response to said outbound data transmission;
scan said inbound data transmission for malicious content using said remote computing system;
determine whether said inbound data transmission is corrupted with said malicious content;
upon determining said inbound data transmission is free of said malicious content:
permit said inbound data transmission to return to said requesting virtual application on said host system; and
upon determining said inbound data transmission is corrupted with malicious content:
block said inbound data transmission from returning to said virtual application on said host system.

2. The system of claim 1, wherein said multi-aspect security module, said processor, and said communications means are operably connected and are further configured to:
allow execution of pre-selected executable code associated with an application during the compilation cycle; and
deny execution of executable code associated with any application that is not pre-selected during the compilation cycle.

3. The system of claim 2, wherein said multi-aspect security module, said processor, and said communications means are operably connected and are further configured to:
create a new sandbox on said host system.

4. The system of claim 1, wherein said encrypted connection is a secure shell providing an encryption tunnel between said host system and said remote computing system that supports multiple protocols selected from a group of protocols comprising web, mail, video conferencing, and instant messaging.

5. The system of claim 1, wherein said said encrypted connection is comprised of one or more encrypted connection types selected from a group of encrypted connection types comprising secure socket layer, secure shell, and virtual private network.

6. The system of claim 1, wherein said inbound data transmission is scanned with signature-based anti-malware engines.

7. The system of claim 1, wherein said inbound data transmission is scanned with heuristic-based anti-malware engines.

8. A method for providing simplified end-to-end security for computing devices in standalone, LAN, WAN or Internet architectures; said method comprising the steps of:
creating a sandbox on a host system upon receiving launch instructions from a user, wherein file associations are generated with said host system;
configuring necessary permissions to said host system, wherein said sandbox establishes read permissions from said host and write permissions to said host system;
establishing an encrypted connection between said host system and a remote computing system;
launching one or more virtual applications from said sandbox on said host system;
requesting authentication from said user to provide access to said remote system via said encrypted connection;
facilitating an outbound data transmission to an external network, wherein said outbound data transmission is sent from a requesting virtual application via said encrypted connection;
receiving an inbound data transmission from said external network, wherein said inbound data transmission is a response to said outbound data transmission;
scanning said inbound data transmission for malicious content using said remote computing system;
determining whether said inbound data transmission is corrupted with said malicious content;
upon determining said inbound data transmission is free of said malicious content:
permitting said inbound data transmission to return to said requesting virtual application on said host system; and
upon determining said inbound data transmission is corrupted with malicious content:
blocking said inbound data transmission from returning to said virtual application on said host system.

9. The method of claim 8, further comprising the steps of:
allowing execution of pre-selected executable code associated with an application during the compilation cycle; and
denying execution of executable code associated with any application that is not pre-selected during the compilation cycle.

10. The method of claim 9, further comprising the steps of:
creating a new sandbox on said host system.

11. The method of claim 8, wherein said inbound data transmission is scanned with signature-based anti-malware engines.

12. The method of claim 8, wherein said inbound data transmission is scanned with heuristic-based anti-malware engines.
